(19) United States
(12) Patent Application Publication
(10) Pub. No.: US 2015/0061853 A1
(43) Pub. Date: Mar. 5, 2015

(54) REPEATER MODULE FOR TIRE PRESSURE MONITORING SYSTEM

(71) Applicant: Cub Elecparts Inc., Fuxing Township (TW)

(72) Inventors: San-Chuan YU, Fuxing Township (TW); Hsiao-Ming CHEN, Tianzhong Township (TW); Ming-Hong LIN, Yuanlin Township (TW); Jyong LIN, Huatan Township (TW)

(73) Assignee: Cub Elecparts Inc., Fuxing Township (TW)

(21) Appl. No.: 14/014,885

(22) Filed: Aug. 30, 2013

(51) Int. Cl. B60C 23/04

(52) U.S. Cl. CPC B60C 23/0479
USPC 340/445

(57) ABSTRACT

A repeater module used in a TPMS and installed in a mother vehicle or daughter vehicle of a tow truck for receiving the status signal from each daughter vehicle tire pressure sensor and providing a corresponding wireless signal to the on-vehicle main unit in the mother vehicle by using the ID code and communication protocol of any mother vehicle tire pressure sensor so that the mother vehicle can receive the status information of the tires of the daughter vehicle without needing to modify the on-vehicle main unit.

### BACKGROUND OF THE INVENTION

1. Field of the Invention

The present invention relates to tire pressure monitoring technology, and more particularly to a repeater module for use in a TPMS (tire pressure monitoring system).

2. Description of the Related Art

To improve driving safety, a vehicle it may be equipped with a tire pressure monitoring system, as shown in FIG. 1. Through linking between an on-vehicle main unit 2 and a tire pressure sensor 4 in each tire 3 of the vehicle 1, the on-vehicle main unit 2 can obtain the status data of each tire 3 so that the driver can know the current status of every tire 3 from a display interface 5 in the vehicle 1, assuring a high level of driving safety.

A tire pressure monitoring system of this design has benefits and limitations. Normally, the settings of the on-vehicle main unit 2 and the display interface 5 are done in factory. The settings of either on-vehicle main unit 2 or display interface 5 are done to fit tires 3 of the vehicle. If the vehicle has four tires, the on-vehicle main unit 2 or display interface 5 can simply receive and display the status of these four tires.

In other words, the on-vehicle main unit 2 and the display interface 5 are configured to fit the original number of tires of the vehicle. If the number of tires of the vehicle is increased, the on-vehicle main unit 2 and the display interface 5 can neither accept the added tire nor provide the status information of the added tire. A vehicle driver may connect a trailer for towing. For example, a vehicle driver may connect a recreational vehicle, boat trailer or water friction trailer to a mother vehicle (powered vehicle). Even if the tires of the trailers are respectively equipped with a tire pressure sensor, the tire pressure sensors in the tires of the trailers still cannot be linked to the on-vehicle main unit in the mother vehicle, and the display interface in the mother vehicle cannot display the status of the tires of the trailers. In order to solve this communication problem, the on-vehicle main unit and the display interface must be modified.

### SUMMARY OF THE INVENTION

The present invention has been accomplished under the circumstances in view. It is the main object of the present invention to provide a repeater module for TPMS (tire pressure monitoring system), which is capable of providing daughter vehicle tire status information.

It is another object of the present invention to provide a repeater module for TPMS (tire pressure monitoring system), which can provide the status information of attached tires without needing to modify the on-vehicle main unit.

It is still another object of the present invention to provide a repeater module for TPMS (tire pressure monitoring system), which facilitating installation and application.

To achieve these and other objects of the present invention, a repeater module of the invention is used in a tire pressure monitoring system and selectively installed in a mother vehicle or daughter vehicle of a tow truck for receiving a status signal from each daughter vehicle tire pressure sensor and providing a corresponding wireless signal to an on-vehicle main unit. The repeater module of the tire pressure monitoring system comprises a MCU, a memory unit electrically connected to the MCU and adapted for storing the ID code and communication protocol of at least one mother vehicle tire pressure sensor, a transmitter unit electrically connected to the MCU and adapted for transmitting a wireless signal to the on-vehicle main unit in the mother vehicle, a receiver unit electrically connected to the MCU and adapted for receiving a status signal from each daughter vehicle tire pressure sensor, and a power source electrically connected to the MCU to provide the repeater module with the necessary working electricity.

Preferably, the power source comprises a power cable connectable to the mother vehicle to obtain power supply from the mother vehicle.

Preferably, the repeater module of the tire pressure monitoring system further comprises an alarm unit electrically connected to the MCU and controllable by the MCU to give off an alarm signal.

Other advantages and features of the present invention will be fully understood by reference to the following specification in conjunction with the accompanying drawings, in which like reference signs denote like components of structure.

### BRIEF DESCRIPTION OF THE DRAWINGS

FIG. 1 is a schematic drawing illustrating structure of a conventional tire pressure monitoring system.

FIG. 2 is a schematic drawing illustrating a repeater module installed in a tire pressure monitoring system in accordance with the present invention.

FIG. 3 is a system block diagram of the repeater module of the tire pressure monitoring system in accordance with the present invention.

### DETAILED DESCRIPTION OF THE INVENTION

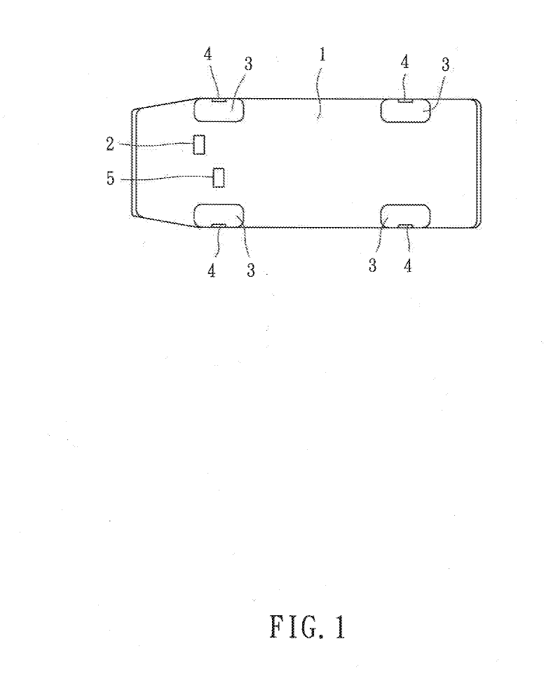

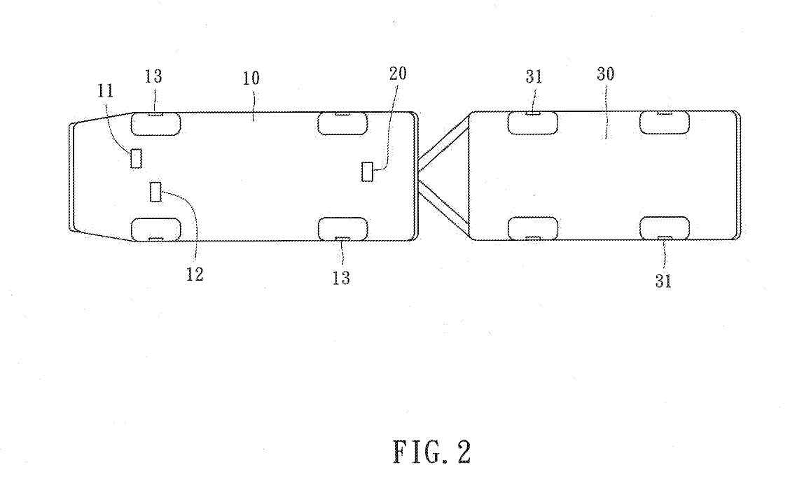

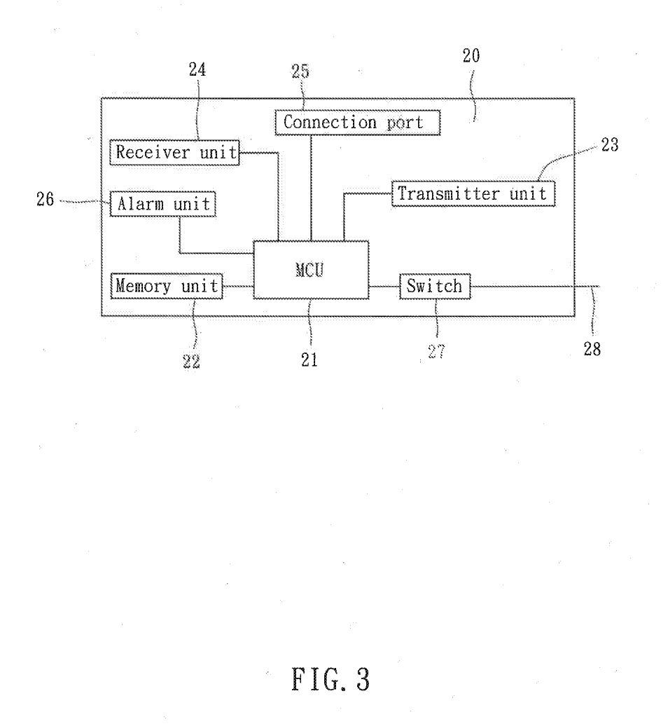

Referring to FIGS. 1-3, a repeater module 20 in accordance with the present invention is shown used in a TPMS (tire pressure monitoring system) and installed in a tow truck's mother vehicle 10 or daughter vehicle 30 for receiving status signals from daughter vehicle tire pressure sensors 31 and transmitting wireless signals to an on-vehicle main unit 11 of the TPMS in the mother vehicle 10.

The repeater module 20 comprises:

a MCU (Micro Control Unit) 21;

a memory unit 22 electrically connected to the MCU 21 and controllable by the MCU 21 to store identification and communication protocol/communication protocol code of at least one mother vehicle tire pressure sensor 13;

a transmitter unit 23 electrically connected to the MCU 21 and adapted for processing the identification and communication protocol/communication protocol code of the at least one mother vehicle tire pressure sensor 13 been stored in the memory unit 22 into a wireless signal and then transmitting the wireless signal to the on-vehicle main unit 11 in the mother vehicle 10;

a receiver unit 24 electrically connected to the MCU 21 and adapted for receiving the status signals provided by the daughter vehicle tire pressure sensors 31;

a connection port 25 electrically connected to the MCU 21 for the connection of an external computer or setting tool that is operable to set or alter the identification and communication protocol/communication protocol code of the tire pressure sensors of the TPMS;

an alarm unit 26 electrically connected to the MCU 21 and controllable by the MCI 21 to give a visual or audio warning signal;

a switch 27 switchable to turn on/off the repeater module 20; and

a power source 28 electrically connected to the switch 27 for providing the repeater module 20 with the necessary electricity for working subject to the switching control of the switch 27. The power source can be a battery, or a powder cable connected to a power socket in the motor vehicle 10.

During application of the present invention, the repeater module 20 of the TPMS can be installed in the mother vehicle 10 and electrically connected to the power circuit of the mother vehicle 10 by the power source (power cable) 28. For example, the repeater module 20 of the TPMS can be installed in the trunk of the mother vehicle 10 and electrically connected to the 12V power source of the mother vehicle 10. After installation, turn on the repeater module 20 of the TPMS to receive the ID of every tire pressure sensor 31 in the daughter vehicle 30, getting the repeater module 20 and every daughter vehicle tire pressure sensor 31 connected. Thereafter, let the ID and communication protocol obtained from any mother vehicle tire pressure sensor 13 be stored in the memory unit 22. During operation of the TPMS, the repeater module 20 receives the status signal provided by every daughter vehicle tire pressure sensor 31 for reading by the MCU 21. If the value of the status signal of every daughter vehicle tire pressure sensor 31 is within the normal range, the repeater module 20 simply keeps receiving the status signal from the daughter vehicle tire pressure sensors 31 without taking any other action.

However, if any daughter vehicle tire pressure sensor 31 exhibits an abnormal condition, for example, the status of “tire pressure too low” or “tire temperature too high”, the repeater module 20 will receive an abnormal status signal from the respective daughter vehicle tire pressure sensor 31. The abnormal status signal will then be interpreted by the MCU 21. After interpretation, the MCU 21 will drive the transmitter unit 23 to transmit a corresponding wireless signal subject to the ID and communication protocol of the mother vehicle 10 to the on-vehicle main unit 11 in the mother vehicle 10, and at the same time, the alarm unit 26 will be driven by the MCU 21 to give off a visual or audio alarm signal. At this time, a display interface 12 in the mother vehicle 10 will give an indication, including the abnormal status of the respective mother vehicle tire pressure sensor 31. Thus, the driver can know the abnormal status of the daughter vehicle without altering the on-vehicle main unit and the display interface, enhancing driving safety.

Further, if the daughter vehicle 30 is to be detached from the mother vehicle 10, directly dismount the power source (power cable) 28 or turn off the switch 27 of the repeater module 20. At this time, the repeater module 20 is stopped from working, and the on-vehicle main unit 11 can simply receive signals provided by the mother vehicle tire pressure sensors 13.

In the TPMS of the present invention, the repeater module 20 and the on-vehicle main unit 11 use the same communication protocol; the on-vehicle main unit 11 and the mother vehicle tire pressure sensors 13 use the same communication protocol. Thus, signals provided by the repeater module 20 are compatible to and directly receivable by the on-vehicle main unit 11. Therefore, the application of the present invention does not need to modify the on-vehicle main unit 11.

Further, by means of the connection port 25, the invention can be connected to an external setting tool for the modification of the communication protocol and ID codes. Further, through the receiver unit 24, the invention can receive a signal from an external setting tool to modify the communication protocol and ID codes.

In case of any daughter vehicle tire abnormality, the alarm unit 26 of the repeater module 20 of the TPMS and the display interface 12 in the mother vehicle 10 will simultaneously give off an alarm. If a mother vehicle tire abnormality occurs, only the display interface 12 will give off an alarm, and the alarm unit 26 of the repeater module 20 of the TPMS will give no signal. Thus, subject to this signaling difference, the driver can discriminate between a mother vehicle tire abnormality and a daughter vehicle tire abnormality.

Further, the frequency of the signal provided by the transmitter unit 23 of the repeater module 20 of the TPMS and the frequency of the signal received by the receiver unit 24 can be same. Further, in order to prevent the on-vehicle main unit in the mother vehicle from receiving the status signal of each daughter vehicle tire pressure sensor in causing confusion, the mother vehicle tire pressure sensors and the daughter vehicle tire pressure sensors can be configured to operate on different frequencies. For example, the mother vehicle tire pressure sensors can be configured to operate on 315 MHz, and the daughter vehicle tire pressure sensors can be configured to operate on 433 MHz. Thus, the on-vehicle main unit can be configured to receive 315 MHz signals only, preventing confusion. In this case, the repeater module is configured to receive 433 MHz status signals and to transmit 315 MHz wireless signals.

What is claimed is:

1. A repeater module used in a tire pressure monitoring system and selectively installed in a mother vehicle or daughter vehicle of a tow truck for receiving a status signal from a daughter vehicle tire pressure sensor in each daughter vehicle tire and providing a corresponding wireless signal to an on-vehicle main unit in said mother vehicle, the repeater module comprising:
a MCU;
a memory unit electrically connected to said MCU and adapted for storing an ID code and communication protocol of at least one mother vehicle tire pressure sensor;
a transmitter unit electrically connected to said MCU and adapted for transmitting a wireless signal to said on-vehicle main unit in said mother vehicle;
a receiver unit electrically connected to said MCU and adapted for receiving a status signal from each said daughter vehicle tire pressure sensor; and
a power source electrically connected to said MCU to provide the repeater module with the necessary working electricity.

2. The repeater module as claimed in claim 1, further comprising an alarm unit electrically connected to said MCU and controllable by said MCU to give off an alarm signal.

3. The repeater module as claimed in claim 1, further comprising a switch electrically connecting said power source to said MCU and switchable to turn on/off the repeater module.

4. The repeater module as claimed in claim 1, wherein said transmitter unit and said receiver unit are configured to operate on the same frequency.

5. The repeater module as claimed in claim 2, wherein said transmitter unit and said receiver unit are configured to operate on the same frequency.

6. The repeater module as claimed in claim 1, wherein said transmitter unit and said receiver unit are configured to operate on different frequencies.

7. The repeater module as claimed in claim 2, wherein said transmitter unit and said receiver unit are configured to operate on different frequencies.

8. The repeater module as claimed in claim 1, wherein said power source comprises a power cable connectable to said mother vehicle to obtain electricity from said mother vehicle.

9. The repeater module as claimed in claim 1, wherein said transmitter unit is adapted to transmit a wireless signal to said on-vehicle main unit in said mother vehicle when the status signal from one said daughter vehicle tire pressure sensor is abnormal.

10. The repeater module as claimed in claim 1, further comprising a connection port for enabling the repeater module to be connected to external means for ID code or communication protocol modification.

11. The repeater module as claimed in claim 2, further comprising a connection port for enabling the repeater module to be connected to external means for ID code or communication protocol modification.
